(19) United States
(12) Patent Application Publication
(10) Pub. No.: US 2005/0080737 A1
(43) Pub. Date: Apr. 14, 2005

(54) Process and system for converting change from cash sale transactions (paper currency and coins) into electronic format at the point of sale for the immediate electronic transfer and deposit of the converted change into financial accounts and the funding of financial accounts at the point of sale

(76) Inventors: Marc F. Stein, Rydal, PA (US); Anthony Argiropoulos, Lawrenceville, NJ (US); Richard Paul Silva, Huntingdon Valley, PA (US)

Correspondence Address: Anthony Argiropoulos, 67 Fountayne Lane, Lawrenceville, NJ, 08648, US

(21) Appl. No.: 10/673,335

(22) Filed: Sep. 30, 2003

(51) Int. Cl. G06F 17/60

(52) U.S. Cl. 705/42; 705/35

(57) ABSTRACT

The present invention relates generally to the process and system and process for converting cash sale transaction residuals (change—the coin and currency returned to a retail cash purchaser as the excess balance due to the purchaser for a transaction) into an electronic form for electronic transfer and deposit into interest bearing accounts at the point of sale through the combination of magnetic cards, magnetic card readers, automatic magnetic card dispensers with identity verifying capabilities and linkage to financial institutions.

### FIELD OF THE INVENTION

The present invention relates to the process for converting the change (i.e. the coin and currency returned to a retail cash purchaser as the excess balance due to the purchaser for a cash exchange for goods transaction) from a retail cash transaction into an electronic format for electronic transfer and deposit into the cash purchaser's accounts with banks or other financial institutions at the point of sale, and the process and system for creating the interest bearing account to be initially funded at the point of sale.

### SUMMARY OF THE INVENTION

The present invention converts the routine cash sales transaction into a banking transaction at the point of sale. It provides cash sale purchasers, i.e. consumers, with the option of electronically depositing their change into a savings or other type of account with a financial institution at the point of sale. The account is linked to the consumer's magnetic stripe card that is issued at by automated and transactional magnetic card dispensing kiosks. The kiosks are linked to a telecommunications network by modem and telephone wire, cable or other secure transmission conduit to the financial institution where the account is situated. The automated and transactional magnetic card dispensing kiosks are situated in places where consumers are more likely to purchase consumer goods for cash, rather than with credit cards or debit cards, such as grocery stores, convenience stores, department stores and fast food restaurants.

A consumer registers with the financial institution by inputting identify verifying data, e.g. social security number, state issued driver's license number, name and zip code into the automated and transactional magnetic stripe card dispensing kiosk. Upon input, the automated and transactional magnetic card dispensing kiosk transmits the information to the participating and linked financial institution. The financial institution then verifies the identifying information. If the information is not verified, the transaction will be cancelled. If the information is verified, then the financial institution will electronically generate a savings-only account that may only be funded electronically by the linked magnetic stripe card dispensed by the automated and transactional magnetic card dispensing kiosk.

After the consumer receives her magnetic stripe card, she may use it to fund the account every time she makes a cash purchase (that results in change due to her) with a participating vendor. Rather than give the consumer her change, the participating vendor will run the consumer's magnetic stripe card through a magnetic card reader. The consumer will verify her intent that the change due to her from the cash sale transaction be electronically deposited into the account using a touch pad connected to the participating vendor's cash register that is linked to a telecommunications network by modem and telephone wire, cable or other secure transmission conduit to the financial institution where the account is situated. Upon verification, the consumer's change will be electronically transferred and deposited into the account.

The consumer's magnetic stripe card may be utilized together with a personal identification number, specific to the consumer, to ascertain the balances of the account(s) with the financial institution at the automated and transactional magnetic card dispensing kiosks or automated teller machines with which the financial institution is registered or electronically linked.

### BACKGROUND AND DESCRIPTION OF PRIOR ART

The hype about the advent of a cashless society has not delivered. Cash transactions remain the most common retail sales transactions despite the availability of debit cards and credit cards. This is because the transaction costs associated with these modes of exchange are cost prohibitive or inconvenient for use in transactions greater than a base-line amount. In addition, the majority of American consumers make multiple cash transactions in one day because it is a more convenient way to purchase a cup of coffee, a sandwich or a retail consumer good.

In addition, the availability and proliferation of automated teller machines has commensurately increased the convenience and ease of the cash transaction by making the consumer's cache of cash available upon demand. It is not uncommon, but rather the norm, for a retail establishment to have an automated teller machine situated at its premises for the convenience of its customers and to encourage cash spending.

It is spending that is the key. Currently, the retail transactional environment is geared to methods of spending, but not methods of saving. The present invention revolutionizes the retail transactional environment by providing the medium through which consumers may save funds, rather than spend them—the electronic conversion of change into electronic format for deposit at the point of sale.

Existing patented processes and methods fail to capture the invention's conversion of the cash sale transaction to a banking transaction at the point of sale—the critical element that separates the invention from all prior art. The invention does not replace the cash transaction, but rather conveniently converts the cash sale transaction to a cashless transaction only with respect to the distribution of change, i.e. cash currency and coinage. A consumer pays with cash, but the consumer's “change” is electronically deposited into a savings account at the point of sale. The conduit for this conversion is a magnetic card programmed to route the “change” directly into a savings, checking, investment or other financial account reserved for the consumer.

None of the prior art concerns the conversion of the cash transaction into a cashless transaction by the conduit of cash transaction residuals (change) into an electronic format for transfer and deposit at the point of sale. To the contrary, the prior art is limited to four general business methods—none of which convert a cash transaction to a cashless transaction at the point of sale.

The known prior art includes U.S. Pat. Nos. 4,694,397; 4,742,457; 5,056,019; 5,287,268; 5,297,026; 5,689,100; 6,164,533; 6,598,024; and 6,601,037, and the prior art disclosed in those patents, which are incorporated by reference. The prior art may be segregated into four categories: (1) “upsell product” or “reward” method; (2) “value card” methods; (3) “debit/credit card deposit” methods and (4) “coin counter/sorter and coupon/voucher dispensing machine method.

A. “Upsell Product” or “Reward” Method.

The Upsell Product or Reward method is where the residual (change) from a transaction may be used to make a purchase or be exchanged for a consumer good at the point of sale.

The Upsell Product or Reward prior art is exemplified by U.S. Pat. No. 6,598,024. Under the '024 patent a point of sale terminal determines an “upsell” to offer in exchange for the change due to a consumer in connection with a purchase. The upsell is a consumer good that corresponds to the amount of change due to a consumer. The consumer has the option of accepting her change or the upsell. If the consumer selects the upsell, then she receives a consumer good instead of the change due her. The '024 patent does not convert a cash transaction into a cashless transaction. Instead, it facilitates the additional purchase of a consumer good to absorb the change due to the consumer.

The Upsell Product or Reward prior art may be illustrated as follows. A consumer purchases goods that cost $17.50. She pays with a $20 bill, and is due $2.50 in change. Through the Upsell Product or Reward prior art she may trade her change for an additional consumer good to purchase. In essence and effect, the consumer does nothing more than purchase an additional consumer good with her change thereby eliminating the necessity of the return of change to the consumer.

Other methods include systems that track a consumer's spending and reward the consumer for spending. These methods are exemplified by U.S. Pat. No. 5,287,268, which incentivize the consumer's use of a credit card by accumulating cash values for based upon point of sale transactions. Similarly, U.S. Pat. No. 5,056,019 concerns a method of accounting for rewards to consumers based upon the use of a credit card.

B. Value Card Method

This is where transaction results in a credit or debit to an electronic purse stored on portable data device or smart card. The Value Card method prior art is generally focused upon the casino gaming environment and it is exemplified by a number of U.S. patents, including U.S. Pat. No. 6,601,771, which concerns a smart card or magnetic stripe card used for exchanging money with a financial institution in a credit or debit transaction that credits or debits an electronic purse resident on card.

In a typical Value Card transaction, a consumer pays $20 to vendor who electronically applies a $20 or other credit to an individual smart card/magnetic stripe card. This card may then be used by consumer for purchases with the vendor.

In the case of a “gift card” a consumer may use the smart card to purchase items with each purchase commensurately depleting the credit balance programmed onto the card until the balance reaches zero. In some instances, the vendor will redeem the card for its cash value when a minimum balance (usually less than $10.00) is reached.

In the gaming/casino environment the card may be presented to gaming devices in a cashless gaming environment to allow the consumers to use the gaming devices. The gaming devices will electronically credit or debit the value of the card depending upon the gamer's performance.

C. Debit/Credit Card Deposit Method

This is where a consumer using a credit card or debit card in a consumer transaction electronically deposits a portion of the residual from the credit card or debit card transaction into a savings or other account at the point of sale. It is exemplified by U.S. Pat. No. 6,164,533. This method automatically contributes monies to a savings program upon making a purchase with a credit or debit card that is linked to an account with a financial institution.

In the case of a debit card, the '771 patent calls for a consumer to deduct a sum from the linked savings, checking or other account (the “Debit Sum”). The '771 patent then calls for a merchant at the point of sale to transfer or contribute the Debit Sum to another designated savings-type account.

In the case of a credit card, the '771 patent calls for a consumer to draw from a line of credit with the financial institution that issued the credit card deduct (the “Draw Sum”). The '771 patent then calls for a merchant at the point of sale to transfer or contribute the Draw Sum to a designated savings-type account. Therefore, the '771 patent involves only the transfer of funds in the context of purely cashless transactions, i.e., debit card and credit card transactions

D. Coin Counter/Sorter and Coupon/Voucher Dispensing Machine and Method

The Coin Counter/Sorter and Coupon/Voucher Dispensing Machine and Method is exemplified by U.S. Pat. No. 6,494,776. It is a method whereby persons may redeem coins into more manageable currency of larger denominations. Through this method, a person pours her collected coins into a coin counter/sorter apparatus that counts and sorts the coins. Then, the coin counter/sorter generates a coupon/voucher that identifies the value of the collected coins. The coupon/voucher's may be redeemed at a cash register in a participating retail establishment for paper and other currency. To illustrate, a person may pour $214.42 in coins into the coin counter/sorter, which will count the coins and issue the coupon/voucher. Upon redemption at a cash register, the redeemer will be issued paper currency and coins from a cash drawer or a cash register.

U.S. Pat. No. 6,032,191 is a similar type of counter/sorter business method. The '191 patent permits a merchant to exchange paper currency for coins on site at a retail establishment, thereby obviating the need for the merchant to travel to a financial institution to exchange paper and other currency for quarters, dimes, nickels and pennies for use as change in cash transactions.

In addition, it permits merchants to make deposits into their accounts with financial institutions by depositing rolled coins into a stationary coin counting apparatus that counts and collects change and verifies the amount due to the person using the apparatus and a rolled coin dispenser for dispensing various denominations of rolled coins.

### OBJECTS AND ADVANTAGES

A. Objects

Several objects and advantages of the present invention are:
1. To provide a system and process for electronically depositing change into a savings, checking, investment, retirement account with a bank or financial institution at the point of sale;
2. To provide a system and process for electronically creating banking relationships at the point of sale;
3. To provide a system and process for the conversion of cash sales transactions into electronic “cashless” transactions at the point of sale;
4. To provide a system and process for using change from cash sales transactions to initially fund financial accounts at the point of sale; and
5. To provide a system and process for using change from cash sales transactions to fund financial accounts at the point of sale.

B. Advantages

The present invention has definitively clear advantages over the prior art. It automatically converts a cash transaction into a cashless transaction that provides an immediately tangible benefit to the consumer, the vendor and the linked financial institution.

The consumer is provided with a simple and convenient way to begin or continue saving her hard-earned money. Instead of misplacing her change, storing it in a jar, losing it in her laundry or keeping it in her ashtray, she may convert it into an interest generating asset.

The vendor generates goodwill with consumers and labor costs and costs associated with the mishandling of cash. The probability of losing money through clerical error is minimized. With no change for a clerk to handle, a vendor's opportunity to misplace or lose money, cash or coin, is significantly minimized. In addition the costs and charges accompanying error reduction strategies, such as customer displays and management oversight and accounting, may be reinfused into the vendor's profit margin. Furthermore, the vendors may charge a nominal fee for the transaction that will consequently and invariably result in a profit increase with no commensurate resource expenses.

Financial institutions have the immediate benefit of the instantaneous creation of a new banking relationship with the consumer together with the immediate and regular infusion of significant volumes of cash into the financial institution from a previously untapped source—the point of sale. These instantaneous banking relationships are generated without the expenditure of traditional overhead or labor costs. Vendors become automated bank tellers that only make deposits, rather than withdrawals. In addition, financial institutions may charge a nominal fee for the transaction that will generate additional revenues.

All of the prior art fails to allow for the conversion of the change from a cash transaction into an electronic format for deposit. Therefore, none of the prior art meets these objectives or delivers these advantages.

### SUMMARY OF FIGURES

FIG. 1 is a flowchart demonstrating the creation of a financial account that is funded at the point of sale by the change due to the consumer/account holder at the point of sale and using a magnetic card reader.

FIG. 2 is a flowchart depicting initial funding of the account by the change due to the consumer/account holder at the point of sale and using a magnetic card.

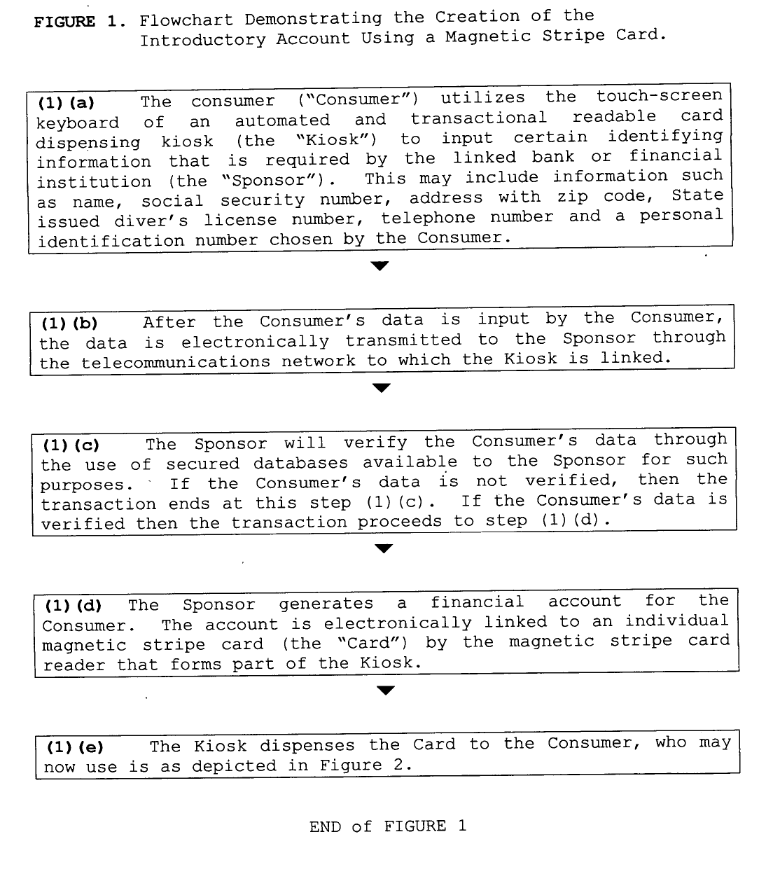

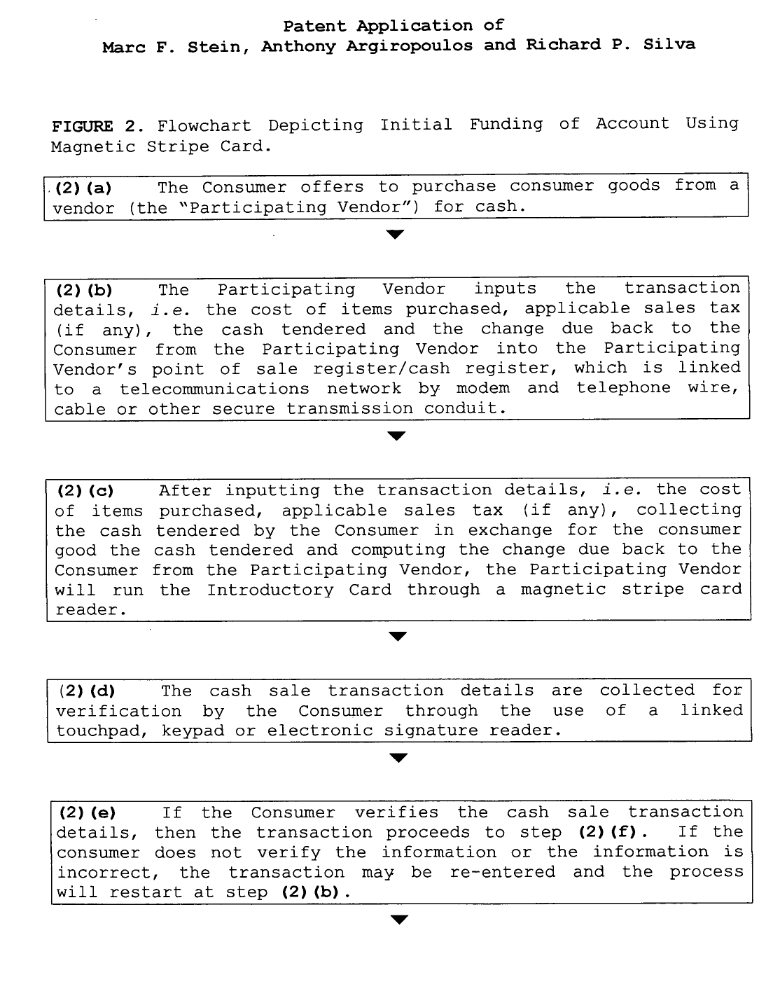

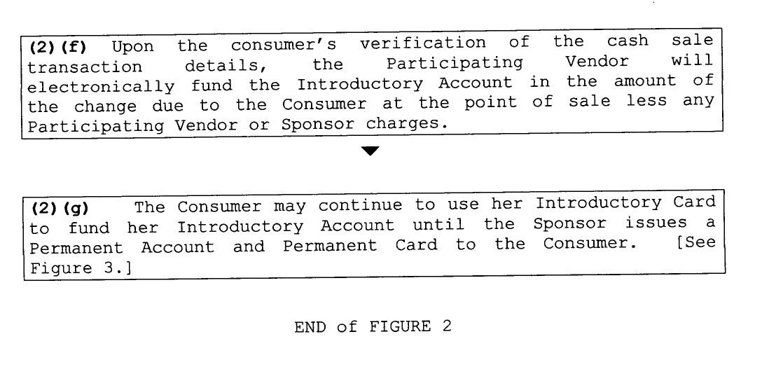

### DETAILED DESCRIPTION OF THE PRESENT INVENTION

The present invention is the process for instantly converting cash sale transaction residuals (i.e. change—paper currency and coins) into electronic form at the point of sale for electronic transfer and deposit into interest bearing accounts created and initially funded at the point of sale.

With respect to this description, the specific equipment, materials, relationships and systems used for accomplishing the point of sale conversion of cash sale transaction residuals (i.e. change—paper currency and coins) into electronic format for electronic transfer and deposit into accounts with banks or other financial institutions would be readily apparent and obvious to one skilled in the art, and all equipment, materials, relationships and systems, in addition to those described in the specification, are intended to be incorporated by the present invention. The present invention is described as follows.

One of the type of a plurality of automated and transactional readable card dispensing kiosk (the “Kiosk”) is situated in the store of a participating vendor (the “Participating Vendor”). The Kiosk is an advanced transactional kiosk of the type composed of a 15″-21“touch screen LCD monitor with shelter glass, a hard-wired modem, a magnetic stripe card reader and a magnetic stripe reader card, a magnetic stripe card dispenser, and magnetic stripe card storage bay/dispenser. The Kisok also incorporates a touch screen keyboard or attached keyboard for the input of data. For example, the Kiosk could be the type of an E-MINK AL-31301 or any other type of kiosk with a 15″-21″ touch screen LCD monitor with shelter glass, a hard-wired modem, a magnetic stripe card reader and a magnetic stripe reader card, a magnetic stripe card dispenser, and magnetic stripe card storage bay/dispenser. The Kiosk is linked to a telecommunications network by modem and telephone wire, cable or other secure transmission conduit.

The Kiosk has a demonstration feature that will provide the consumer/cash sale purchaser (the “Consumer”) with a tutorial about the present invention. The demonstration feature shows how upon the entry of certain identify verifying information, an introductory savings account will be opened with a sponsoring financial institution (the “Sponsor”). Thereafter, when making a cash purchase with a Participating Vendor, the Consumer may elect to have her change from that cash transaction electronically deposited into the account with the Sponsor. The demonstration is an animated continuous loop of a Shockwave or similar type of computer readable file.

The Kiosk becomes interactive when the Consumer touches its LCD touch-screen. The Kiosk will request that the consumer utilize the touch-screen keyboard or other attached keyboard to enter certain identifying information. The specific identifying information will be dependent upon the Sponsor preferences, but may include information such as name, social security number, address with zip code, State issued diver's license number, telephone number and a personal identification number chosen by the Consumer.

After the requested data is input by the Consumer, the data is electronically transmitted to the Sponsor through the telecommunications network to which the Kiosk is linked. At this point, the Sponsor opens a financial account (the “Account”). The Account is electronically linked to an individual temporary magnetic stripe card (the “Card”) by the magnetic stripe card reader that forms part of the Kiosk.

After the Card is linked to the Account and dispensed by the Kiosk to the Consumer, the Consumer may immediately use it to deposit change from sales transactions into the Account at the point of sale. This process is described as follows.

The Consumer purchases consumer goods using cash. The cash is collected by the Participating Vendor's store clerk who records the transaction using the Participating Vendor's point of sale register/cash register, which is linked to a telecommunications network by modem and telephone wire, cable or other secure transmission conduit. The point of sale register/cash register is equipped to subtotal the price of the goods sold and calculate any associates sales tax (if any). The point of sale register/cash register should also be equipped with a customer display, card reader, touchpad, keypad or electronic signature reader and printer.

The point of sale register/cash register may utilize one of a plurality of touch screen monitor with data processor and cash drawer. For example, the touch screen monitor may be of the 3M/Microtouch Flat panel —15” Desktop Serial Capacitive Touch Monitor with Multimedia Package type, the Microtouch 15” CRT Monitor with Capacitive Touch Screen, Serial Controller type or the 15″ LCD with ELO Accutouch Resistive type. The cash drawer may be of the MMF ECD200 18.8W×15.7D×3.9H (+0.00) type, the Citizen Printer Interface Logic Control Drawer type, the Ithaca Printer Interface Logic Control Drawer type or the Epson Printer Interface Logic Controls Drawer type.

All of these components should be used with one of a plurality of compatible printers to print a record of all transactions, such as the Epson TM-U200D Dot-Matrix with Tear Bar type, Epson TM-T88111 Thermal Receipt Printer w/Power Supply & Cable type or Star Micronics SP500 Dot Matrix Receipt Printer type. The components may also be used with and compatible pole displays, such as the adjustable EMAX Pole Display type.

After inputting the transaction details, i.e. the cost of items purchased, applicable sales tax (if any), the cash tendered and the change due back to the Consumer from the Participating Vendor, the Participating Vendor's clerk will run the Card through a magnetic stripe card reader. The transaction details will be collected for verification by the Consumer. The magnetic stripe card reader will transmit the data to the Sponsor upon the Consumer's verification of the change to be deposited into the Account less any transaction charge by the Participating Vendor or the Sponsor or both. The Consumer will verify this information through the use of a linked touchpad, keypad or electronic signature reader.

Upon the Consumer's verification of the transaction details, she authorizes the transfer of her change to the Account through the touchpad, keypad or electronic signature reader.

Upon verification, the Participating Vendor electronically transmits the verified cash value directly into the Account. The change will begin to collect interest immediately or at such time that it has accumulated to a value set by the Sponsor e.g. $100.

From this point forward, the Consumer may use the Card to fund her account(s) every time she makes a cash purchase with a Participating Vendor which results in change. Rather than give the Consumer her change, the Participating Vendor will automatically and electronically deposit the change into the Consumer's account(s) with the Sponsor.

With respect to this description, the specific equipment, materials, relationships and systems used for accomplishing the point of sale conversion of cash sale transaction residuals (i.e. change—paper currency and coins) into electronic format for electronic transfer and deposit into accounts with banks or other financial institutions would be readily apparent and obvious to one skilled in the art, and all equipment, materials, relationships and systems in addition to those described in the specification are intended to be incorporated by the present invention.

In addition, it is expected and understood by one skilled in the art that the Sponsor may be required to make certain disclosures or provide to or obtain from the Consumer certain information. The Sponsor may modify the process and system of the current invention to accommodate industry and state specific rules and regulations or to ensure compliance with all applicable law. Moreover, it is expected and understood by one skilled in the art that Consumer's may elect to allocate their converted change in one or more of a plurality of types of accounts, such as investment accounts, savings accounts, accounts with charities or college savings accounts and that a Sponsor may use traditional paper methods or interactive website methods to permit Consumers to make election or decisions concerning the allocations.

Therefore, as noted above the description is illustrative of the principles of the present invention, and because change, modification and expansion of the elements utilized by the will readily occur to those skilled in the art, the present invention cannot be limited to the specific formulation and operation described. Therefore, all suitable modifications, expansions and equivalents that would readily occur to one skilled in the art are incorporated by and lay within the present invention's scope.

1. The process and system for the conversion of cash sale transaction residuals (i.e. change—paper currency and coins) into electronic format at the point of sale;

2. The process and system for the point of sale conversion of cash sale transaction residuals (i.e. change—paper currency and coins) into electronic format for electronic transfer and deposit into accounts with banks or other financial institutions;

3. The process and system of claim 2 wherein the electronically converted change is electronically transferred and deposited into the cash purchaser's accounts with banks or other financial institutions at the point of sale;

4. The process and system of claim 2 wherein the electronically converted change is electronically routed, transferred and deposited into the cash purchaser's accounts with banks or other financial institutions at the point of sale through the use of a magnetic stripe card that identifies the card-holder and the account to which the electronically converted change must be routed, transferred and deposited when read by a scanner or card reading device affixed to the point of sale register/cash register;

5. The process and system of claim 2 wherein the electronically converted change is electronically routed, transferred and deposited into the cash purchaser's accounts with banks or other financial institutions at the point of sale through the use of a readable card that identifies the card-holder and the account to which the electronically converted change must be routed, transferred and deposited when read by a scanner or card reading device affixed to the point of sale register/cash register;

6. The process and system of claim 2 wherein the vendor charges a fee to the individual account holder for the conversion of cash sale transaction residuals (i.e. change—paper currency and coins) into electronic format at the point of sale;

7. The process and system of claim 2 wherein the vendor charges a fee to the bank or financial institution for the conversion of cash sale transaction residuals (i.e. change—paper currency and coins) into electronic format at the point of sale;

8. The process and system of claim 2 wherein the vendor charges a fee to the individual account holder for the point of sale conversion of cash sale transaction residuals (i.e. change—paper currency and coins) into electronic format for electronic transfer and deposit into accounts with banks or other financial institutions;

9. The process and system of claim 2 wherein the vendor charges a fee to the bank or financial institution for the point of sale conversion of cash sale transaction residuals (i.e. change—paper currency and coins) into electronic format for electronic transfer and deposit into accounts with that or financial institution;

10. The process and system of claim 3 wherein the bank or other financial institution to which the electronically converted change is electronically transferred and deposited charges a fee for such transfer and deposit to the individual account holder;

11. The process and system of claim 3 wherein the bank or other financial institution to which the electronically converted change is electronically transferred and deposited charges a fee for such transfer and deposit to the vendor;

12. The process and system of claim 2 where the accounts with the banks or other financial institutions are generated and opened by individuals and banks or other financial institutions through the use of automated and transactional readable card dispensing kiosks that are linked to telecommunications networks and to the bank or other financial institution through the telecommunications network;

13. An article of manufacture as set forth in claim 12 for an automated and transactional readable card dispensing kiosk that is linked to telecommunications network and facilitates the generation and opening of an individual account with a bank or financial institution linked to the automated and transactional readable card dispensing kiosk;

14. The process and system of claim 12 where the balances of an individual's account(s) with the banks or other financial institutions may be displayed by the automated and transactional readable card dispensing kiosks that are linked to telecommunications networks;

15. The process and system of claim 2 where the account is a savings, checking or deposit account.

16. The process and system of claim 2 where the account is an investment account, including retirement accounts such as 401K accounts and IRA accounts;

17. The process and system of claim 2 where the account is an investment account, including higher education savings accounts such as state sponsored 529 accounts;

18. The process and system of claim 2 where the account is linked to charitable organization's account for direct electronic donation to said charitable organization;

19. The process and system of claim 2 where the balances in an account with a bank or other financial institution, which account is generated by an automated and transactional readable card dispensing kiosk that is linked to telecommunications networks, may be allocated at the individual account holders discretion through the use of a website.
